(19) United States
(12) Patent Application Publication
(10) Pub. No.: US 2015/0133118 A1
(43) Pub. Date: May 14, 2015

(54) CIRCUIT-SWITCHED CALL DELIVERY

(71) Applicants: Anders H. Askerup, Omaha, NE (US); Bradley T. Kenyon, Omaha, NE (US); Lee Barton Valerius, Carrollton, TX (US); Mark A. Montz, Elkhorn, NE (US)

(72) Inventors: Anders H. Askerup, Omaha, NE (US); Bradley T. Kenyon, Omaha, NE (US); Lee Barton Valerius, Carrollton, TX (US); Mark A. Montz, Elkhorn, NE (US)

(21) Appl. No.: 14/401,061

(22) PCT Filed: Aug. 29, 2012
(86) PCT No.: PCT/US2012/052938

§ 371 Date: Nov. 13, 2014

(51) Int. Cl. H04W 8/04; H04W 8/26

(52) U.S. Cl. CPC H04W 8/04; H04W 8/26
USPC 455/435.1

(57) ABSTRACT

Example embodiments disclosed herein relate to implementing a circuit-switched (CS) call delivery to a mobile device. An unstructured supplementary service data (USSD) message is sent to the mobile device to return to a CS domain. If the mobile device has returned to a first mobile switching center (MSC) of the CS domain, the call is delivered. If the mobile device has not returned to the first MSC, a duration of time set for the mobile device to register with a second MSC of the CS domain and the call is delivered if registration is complete within the duration of time.

### BACKGROUND

Mobile devices have become increasingly popular. Moreover, advancements in technology have resulted in development of various mobile communication standards for delivering high-capacity data and voice services to the mobile devices. Users of mobile devices are constantly moving, thereby roaming and camping in different networks. Network service providers are challenged to provide high quality voice and data services as mobile devices roam and camp in networks.

### BRIEF DESCRIPTION OF THE DRAWINGS

The following detailed description references the drawings, wherein:

FIG. 1 is a block diagram of a network architecture for implementing a circuit-switched (CS) call delivery, according to one example;

FIG. 2 is a block diagram of a home location register (HLR) for implementing a CS call delivery, according to one example;

FIG. 3 is a flowchart of a method for implementing a CS call delivery, according to one example;

FIG. 4 is a flowchart of a method for implementing a CS call delivery, according to one example; and

FIG. 5 is an HLR including a machine-readable storage medium encoded with instructions for implementing a CS call delivery, according to one example.

### DETAILED DESCRIPTION

many mobile devices are capable of switching from one network to the other to receive desired services. For example, a mobile device may switch between a packet-switched (PS) network such as the third generation partnership project (3GPP) long term evolution (LTE) network to receive data, and a circuit-switched (CS) network to receive voice calls. The CS network may include, for example, a third generation (3G) network, a global system for mobile communications (GSM) network, a universal mobile telecommunications system (UMTS) network, and a code division multiple access (CDMA) network.

The LTE, a PS domain network, in a high-speed, high-capacity data standard that is becoming increasing popular as more users acquire smartphones and desire high data rates. However, voice is still a vey important service in mobile communications. Accordingly, it is important that a mobile device is able to receive voice calls in the CS domain even while currently operating in the PS domain (e.g., a fallback from the PS domain to the CS domain to receive voice calls) However, too often mobile terminating calls (e.g., calls to a mobile device) are lost or undeliverable to the mobile device when the mobile device has moved beyond a radio footprint of an original (or last known) CS mobile switching center (MSC) that paged the mobile device for the incoming call. This result is in a problem where, although the mobile device has returned to a CS domain, the call is undeliverable because the mobile device is in a new CS MSC different from the original MSC with which the mobile device originally registered. In such a situation, the call may be routed to voicemail even though the user is available and the call should have been delivered to the user.

Using a mobile terminating roaming retry (MTRR), a standards based approach, to resolve this problem may be expensive because the MTRR solution requires changes to both a gateway MSC and a home location register (HLR). For example, significant hardware and software upgrade may be needed to implement the MTRR solution.

Accordingly, various embodiments disclosed herein relate to implementing CS call delivery. In one example, a CS node (e.g., Cs network registration node) is used for implementing the CS call delivery. In one embodiment, the CS node is an HLR. For example, when a mobile terminating call is received at the HLR, the HLR generates and sends an unstructured supplementary service data (USSD) message to a first MSC of the CS domain, where the first MSC is a last registered MSC of the mobile device known to the HLR. The USSD message is to inform the mobile device of the incoming call and to instruct the mobile device to return to the CS domain. A response to the USSD is received from the first MSC at the HLR. IF the response indicates that the mobile device has returned to the first MSC, the call is delivered to the mobile device via the first MSC. If, however, the response indicates that the mobile device has not returned to the first MSC (e.g., the subscriber is absent from the first MSC), a timer is set to determine if the mobile device will register with a second MSC in the CS domain. Thus, the HLR is able to determine whether or not a subscriber associated with the mobile device is truly absent (e.g., mobile device is powered off, outside coverage area, etc) or whether the mobile device will soon register with another MSC. If registration with the second MSC occurs within the duration of time set by the timer, the call is delivered to the mobile device via the second MSC.

In one example, the duration of time is configurable by the HLR and the duration of time is a time sufficient for a mobile device returning to a CS domain to register with an MSC. In one embodiment, the duration of time is in the order of one second.

In certain examples, when it is confirmed that the mobile device has returned to the first MSC, a provide routing number (PRN) request is sent from the HLR to the first MSC, where the PRN request is to obtain a routing number usable for delivering the call to the mobile device. In other examples, when registration with the second MSC is completed within the duration of time, a second PRN is sent from the HLR to the second MSC, where the second PRN request is to obtain a second routing number usable for delivering the call to the mobile device.

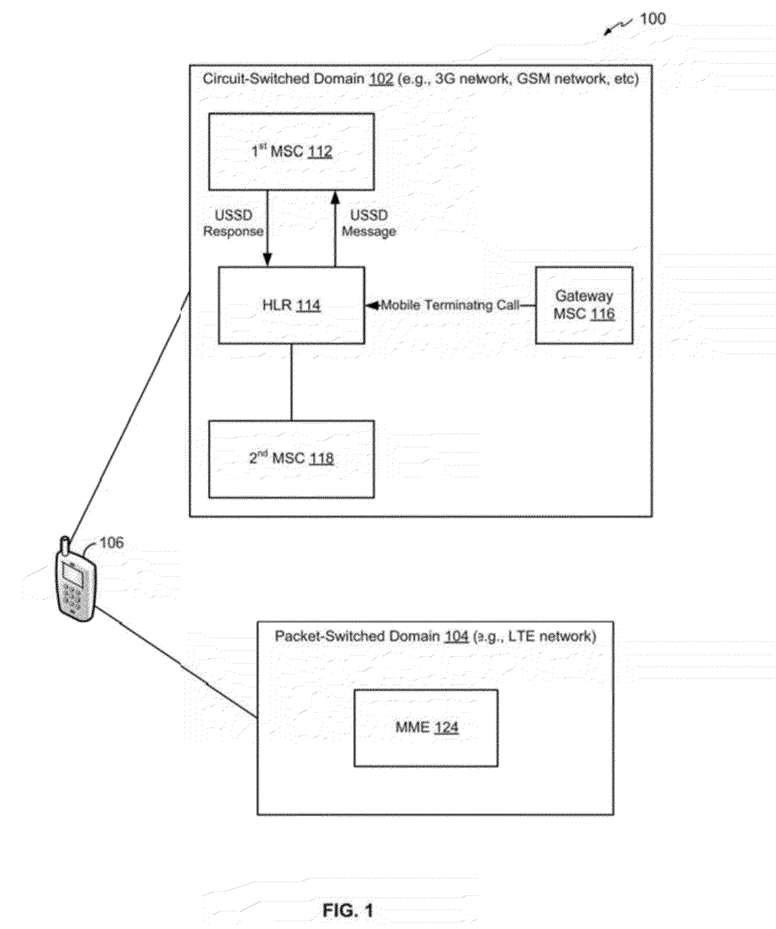

FIG. 1 is a block diagram of a mobile communications system including a HLR for implementing a CS call delivery, according to one example. System 100 includes, for example, a circuit-switched (CS) network domain 102, a packet-switched (PS) network domain 104, and a mobile device 106.

In certain examples, CS domain 102 may include a 3G network, a GSM network, a UMTS network, a W-CDMA network, a TD-SCDMA network, or any other circuit-switched network. The CS domain 102 can handle voice traffic in system 100. For example, the CS domain 102 may implement a dedicated communications channel between two network nodes for the duration of the connection. It should be noted that in certain embodiments, the CS domain 102 may also manage data traffic (e.g., short message service (SMS)). CS domain 102 may include first MSC 112, second MSC 118, HLR 114, and gateway MSC 116,

First MSC 112, second MSC 118, and gateway MSC 116 are responsible for routing voice calls and other network services (e.g., SMS, conference calls, FAK, and circuit-switched data) to mobile devices within the network service provider's network. Further, MSCs 112, 116, 118 may also set up and release end-to-end connections and handle mobility and hand-over requirements during a call. MSCs 112, 116, 118 may determine the location of a subscriber's mobile device 106 within the CS domain 102 and the PS domain 104. MSCs 112, 116, 118 may also interface with a public switched telephone network (PSTN) and all mobile-to-mobile calls and PSTN-to-mobile calls may be routed through MSCs 112, 116, 118.

In one example, mobile terminating calls to a subscriber's mobile device 106 are received at the gateway MSC 116. For example, the gateway MSC 116 interfaces with the PSTN and other networks, thereby providing a gateway function for the CS domain 102. In certain examples, the first MSC 112 is a last registered MSC of the mobile device 116 last known to the HLR 114. For example, the first MSC 112 may be a current serving MSC of the mobile device 106 (e.g., prior to camping on the PS domain 104). In other examples, the second MSC 118 is at MSC with which the mobile device is requesting registration (e.g., a neighboring MSC of the first MSC 112), for example, when returning to the CS domain 102. To illustrate, the mobile device 106 may leave the CS domain 102 and enter the PS domain 104, for example, for data services. Upon returning to the CS domain 102 (e.g., for a voice call), the mobile device may return to a different MSC from which it the mobile device 106 was originally registered. Accordingly, the mobile device 106 may request or may be in a process of registering with the second MSC 118. In certain examples, the second MSC 118 is a visited MSC where the subscriber is currently located.

HLR 114 may store information associated with subscribers of mobile devices of the network provider's network. Information maintained by HLR 114 may include unique identifiers associated with subscribers (e.g., subscriber identity module (SIM) and international mobile subscriber identity (IMSI) information), subscriber telephone numbers, current location of subscriber mobile devices, and subscriber preferences. Accordingly, HLR 114 is able to identify a current serving MSC of the mobile device 106 based in information stored. HLR 114 may be communicatively coupled to the gateway MSC 116 to receive mobile terminating call destined for a particular subscriber. A mobile terminating call is an incoming call to a mobile device.

PS domain 104 may include, for example, an LTE network, a WLAN network, an IP network, or any packet-switched network for providing packet-switched services to mobile device 106 in the system 100. Packet-switched services may include voice-over internet protocol (VOIP) services and data services. PS domain 104 may include MME 124 to provide mobility management functionality to the PS domain 104. For example, the MME 124 may page mobile device 106 camping in the PS domain 104. The PS domain 104 may communicate or interface with the CS domain 102 via the MME 124. For example, MME 124 may be communicatively coupled to one or more MSCs in the CS domain 102 via Gs and SGs, where Gs and SGs are industry standard interfaces.

Mobile device 106 may include, for example, a smartphone, a mobile phone, a personal digital assistant (PDA), a portable personal computer, a portable reading device, a multimedia player, an entertainment unit, or a data communication device capable of communicating voice and data in both the CS domain 102 and the PS domain 104.

When a mobile terminating call to mobile device 106 is received at the HLR 114, a USSD message is generated by HLR 114 and sent to the first MSC 112. The USSD message is to notify the mobile device 106 of the call and to instruct the mobile device 106 to return to the CS domain 102 to receive the call. The first MSC 112 may page the mobile device 106 to return to the CS domain 102. Alternatively, or in addition, the first MSC 112 may communicate with MME 124 in the PS domain 104 and MME 124 may page the mobile device 106. In response to the page, the mobile device 106 may return to the first MSC 112 (e.g., the MSC with which the mobile device 106 is registered) or may return to the second MSC 118 (e.g., a different MSC than the one on which the mobile device 106 is registered). If the mobile device 106 returns to the first MSC 112, the first MSC 112 sends a USSD response indicating that the mobile device 106 has returned to the first MSC 112. Accordingly, the HLR 114 sends a PRN request to the first MSC 112 to obtain a routing number for delivering the call to the mobile device 106. Responsive to the PRN request, the first MSC 112 provides a mobile station routing number (MSRN) for delivering the call to the mobile device 106.

If, however, the USSD response does not indicate that the mobile device 106 has returned to the first MSC 112, then a timer is set at the HLR to determine whether the mobile device 106 registers with the second MSC 112 within a duration of time. For example, the USSD response from the first MSC 112 may indicate an absent subscriber. Accordingly, the HLR 114 determines whether the absent subscriber is a true absent subscriber where the mobile device 106 is shut down, unavailable, outside coverage area and the like, or a false absent subscriber where the mobile device 106 is in the process of registering with the second MSC 118. Based on the determination, false absent subscriber indication that lead to undeliverable calls to an available subscriber may be significantly reduced in the system 100. Thus, if the mobile device 106 registers with the second MSC 118 within the duration of time, HLR 114 sends a PRN request to the second MSC 118 to obtain a MSRN for delivering the call to the mobile device 106.

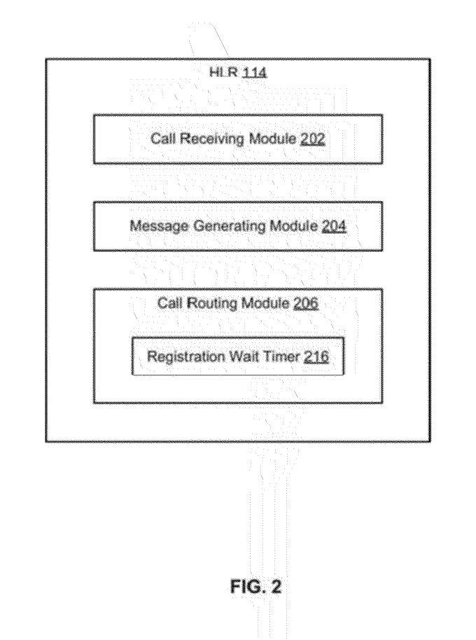

FIG. 2, is a block diagram of an HLR for implementing a CS call delivery, according to one example. In this example, HLR 114 includes a call receiving module 202, a message generating module 204, and a call routing module 206. Call routing module 206 includes a registration wait timer 216.

Call receiving module 202 may be configured to receive a mobile terminating call to mobile device 106. For example, the mobile terminating call may be received from gateway MSC 116. Message generating module 204 may be configured to generate a USSD message. for example, the message generating module 204 may generate the USSD message responsive to receiving the mobile terminating call. The USSD message may be to notify the mobile device 106 of the call and may include a CS fallback command instructing the mobile device 106 to return to the CS domain 102 to receive the call. In one example, the USSD message is a short message for communication between mobile device 106 and the CS domain 102 and components therein (e.g., HLR 114, first MSC 112, second MSC 118, and gateway MSC 116).

Call routing module 206 may be configured to send the USSD message to the mobile device 106. For example, call routing module 206 may send the USSD message to the mobile device 106 via the first MSC 112. In an example embodiment, the USSD message is confirmed by the first MSC 112. For example, the first MSC 112 may send a response indicating a normal completion of the USSD message or an absent subscriber response. A normal completion response may indicate that the mobile device 106 has returned to the first MSC 112 and an absent subscriber response may indicate that the mobile device 106 is absent from the first NSC 112 (e.g., if the mobile device 106 does not return to the first MSC 112).

If the response indicates that the mobile device 106 has returned to the first MSC 112, the call routing module 206 obtains a first routing number from the first MSC 112 for delivering the call to the mobile device 106. If, however, the response indicates that the mobile device is absent from the first MSC 112, the call routing module 206 waits for a duration of time for the mobile device 106 to register with the second MSC 118. IN an example embodiment, the registration wait timer 216 is set to determine whether the mobile device 106 registers with the second MSC 118 within the duration of time. The duration of time may be configured by the HLR 114 and may be in the order of one second. If the mobile device 106 registers with the second MSC 118 within the duration of time, the call routing module 206 obtains a second routing number from the second MSC 112 for delivering the call to the mobile device 106. In one example, the first routing number and the second routing number are different. In another example, the first routing number and the second routing number may be the same.

If the mobile device 106 does not register with the second MSC 118 within the duration of time, the call may be delivered to a voicemail of the mobile device. In this example, the mobile device 106 may be truly unavailable to receive the mobile terminating call. For example, the mobile device may be powered off, have a low battery, or outside a network coverage, and so on.

Each of the modules 202, 204, and 206 may include, for example, hardware devices including electronic circuitry for implementing the functionality described herein. In addition or as an alternative, each module 202, 204, and 206 may be implemented as a series of instructions encoded in a non-transitory machine-readable storage medium.

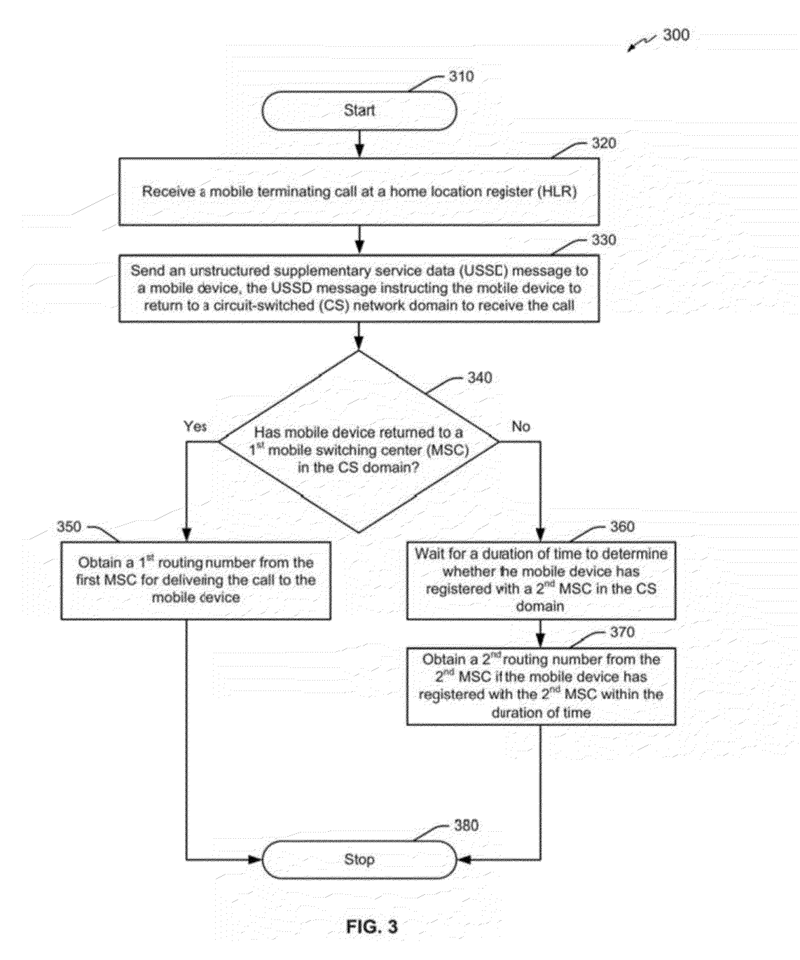

FIG. 3 is a flowchart of a method 300 for implementing a CS call delivery, according to one example. Although execution of method 300 is described below with reference to HLR 114, other suitable components for execution of method 300 can be utilized (e.g., a CS network registration node). In addition, the components for executing the method 300 may be spread among multiple devices. Method 300 may be implemented in the form of executable instructions stored in one or more non-transitory machine-readable storage media and/or in the form of electronic circuitry.

Method 300 may start in block 310 and proceed to block 320, where a mobile terminating call is received at a home location register (HLR). For example, HLR 114 may receive the mobile terminating call from the gateway MSC 116.

The method 310 may proceed to block 330, where a USSD message is sent to the mobile device. The USSD message may instruct the mobile device 106 to return to the CS domain 102 to receive the call. For example, the HLR 114 may send the USSD message to the mobile device 106 via the first MSC 112, where the first MSC 112 is a last known registered MSC of the mobile device 106.

Method 300 may proceed to block 340, where it is determined whether the mobile device has returned to the first MSC in the CS domain. For example, the determination may be based on a response received from the first MSC 112. If it is indicated that the mobile device 106 has returned to the first MSC 112, the method 300 proceeds to block 350, where a first routing number is obtained from the first MSC. For example, the HLR 114 may send a PRN to the first MSC 112 to obtain the first routing number, where the first routing number is usable for delivering the call to the mobile device 106. However, if it is indicated that the mobile device 106 has not returned to the first MSC 112, the method proceeds to block 360, where a duration of time is set to determine whether the mobile device has registered with the second MSC in the CS domain. For example the HLR 114 may set the registration wait timer 216 to expire after a specified time period (e.g., one second). If the mobile device 106 is registered with the second MSC 118 within the duration of time, the method proceeds to block 370, where a second routing number is obtained from the second MSC. For example, the HLR 114 may send a PRN to the second MSC 118 to obtain the second routing number. Method 300 may then proceed to block 380, where the method 300 stops.

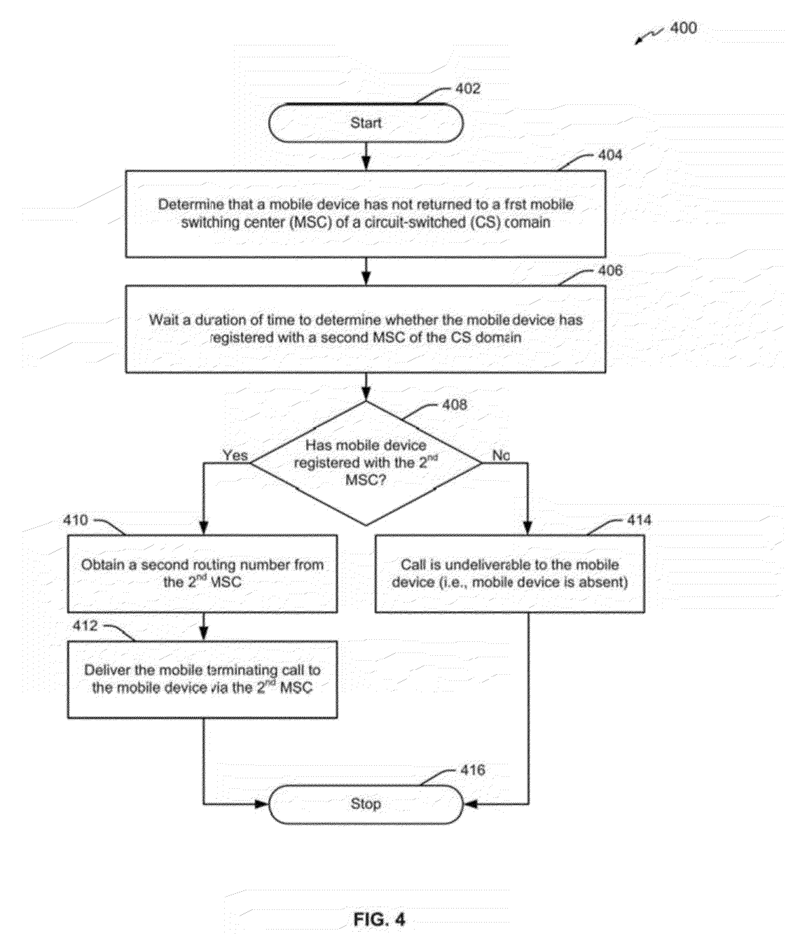

FIG. 4 is a flowchart of a method 400 for implementing a CS call delivery, according to one example. Although execution of method 400 is described below with reference to HLR 114, other suitable components for execution of method 400 can be utilized (e.g., a CS network registration node). In addition, the components for executing the method 400 may be spread among multiple devices. Method 400 may be implemented in the form of executable instructions stored on one or more non-transitory machine-readable storage media and/or in the form of electronic circuitry.

Method 400 may start in block 402 and proceed to block 404, where it is determined that a mobile device has not returned to a first MSC of a CS domain. For example, the HLR 114 may determine that the mobile device 106 has not returned to the first MSC 112, based on the response to the USSD message sent to the first MSC 112.

Method 400 may proceed to block 406, where a timer is set to determine whether the mobile device has registered with a second MSC of the CS domain. For example, the registration wait timer 216 may be set to a duration of time (e.g., one second) to determine whether the mobile device 106 will register with the second MSC 118 within the duration of time.

Method 400 may proceed to block 408, where it is determined whether the mobile device has registered with the second MSC within the duration of time. If it is determined that the mobile device 106 has registered with the second MSC 118, the method 400 proceeds to block 410, where a second routing number is obtained from the second MSC. The method 400 may then proceed to block 412, where the mobile terminating call is delivered to the mobile device via the second MSC. If it is determined at block 408 that the mobile device 106 has not registered with the second MSC 118 within the duration of time, the method 400 proceeds to block 414, where the call is undeliverable to the mobile device. For example, the call may be placed in a voicemail of the mobile device 106. The method 400 may then proceed to block 416, where the method 400 stops.

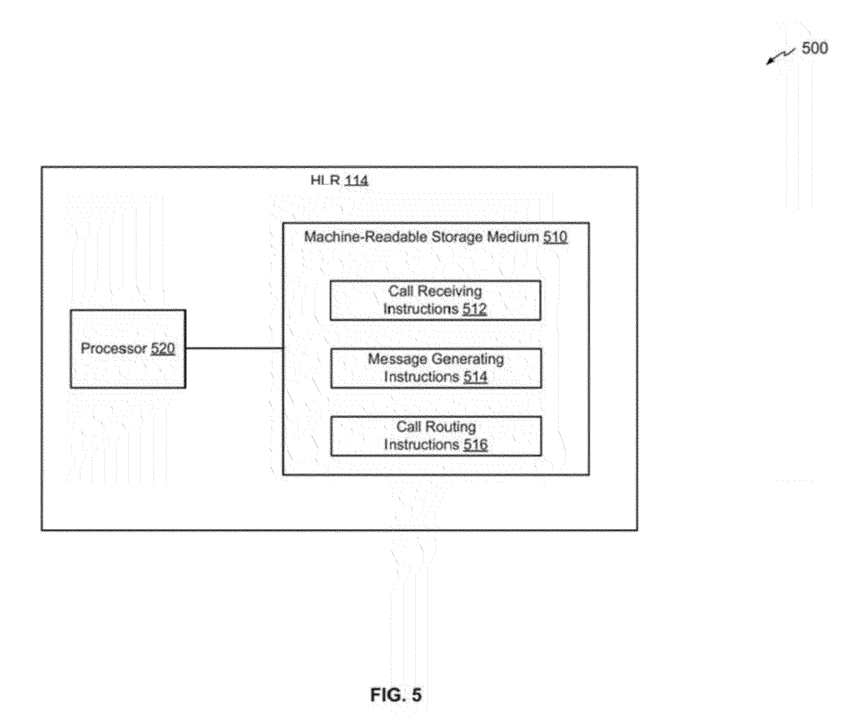

FIG. 5 is a block diagram of an HLR including a machine-readable storage medium encoded with instructions for implementing a CS call delivery, according to one example. The HLR 114 includes, for example, a processor 520 and a machine-readable storage medium 510 including instructions 512, 514, and 516 for implementing a CS call delivery.

Processor 510 may be a microprocessor, a semiconductor-based microprocessor, other hardware devices or processing elements suitable for retrieval and execution of instructions stored in machine-readable storage medium 510, or any combination thereof. Processor 520 may fetch, decode, and execute instructions stored in machine-readable storage medium 510 to implement the functionality described in detail below. As an alternative or in addition to retrieving and executing instructions, processor 520 may include at least one integrated circuit (IC), other control logic, other electronic circuits, or any combination thereof that include a number of electronic components for performing the functionality of instructions 512, 514, and 516 stored in machine-readable storage medium 510. Further, processor 520 may include single or multiple cores in a chip, include multiple cores across multiple devices, or any combination thereof.

Machine-readable storage medium 510 may be any non-transitory electronic, magnetic, optical, or other physical storage device that contains or stores executable instructions. Thus, machine-readable storage medium 510 may be, for example, NVRAM, Random Access Memory (RAM), an Electrically Erasable Programmable Read-Only Memory (EEPROM), a storage drive, a Compact Disc Read Only Memory (CD-ROM), and the like. Further, machine-readable storage medium 510 can be computer-readable as well as non-transitory. As described in detail below, machine-readable storage medium 510 may be encoded with a series of executable instructions for implementing a CS call delivery. Other suitable formats of the executable instructions will be apparent to those of skill in the art.

Machine-readable storage medium 510 may include call receiving instructions 512, which may be configured to receive a mobile terminating call. For example, the mobile terminating call may be received from gateway MSC 116.

Machine-readable storage medium 510 may include message generating instructions 514, which may be configured to generate a USSD message. For example, the USSD message is to notify the mobile device 106 of the call and to instruct the mobile device 106 to return to the CS domain 102.

Machine-readable storage medium 510 may also include call routing instructions 515, which may be configured to send the USSD message to a first MSC of the CS domain. For example, the USSD message may be sent to the first MSC 112, a last known registered MSC of the mobile device 106. The call routing instructions 516 may be configured to obtain a first routing number from the first MSC when a response to the USSD message indicates that the mobile device has returned to the first MSC. The first routing number may be used to route or deliver the call to the mobile device. The call routing instructions 516 may further be configured to wait for a duration of time to determine whether the mobile device has registered with a second MSC when the response indicates that the mobile device has not returned to the first MSC. For example, the call routing instructions 515 may set a timer to expire after a period of time (e.g., one second). If the mobile device has registered with the second MSC within the period of time, the call routing instructions may be configured to obtain a second routing number from the second MSC, the second routing number usable for delivering the call to the mobile device.

What is claimed is:

1. A method for implementing a circuit-switched (CS) call delivery, comprising:
receiving a mobile terminating call at a home location register (HLR);
sending an unstructured supplementary service data (USSD) message to a mobile device, the USSD message instructing the mobile device to return to a CS network domain to receive the call;
if a response to the USSD message indicates that the mobile device has returned to a first mobile switching center (MSC) of the CS domain, obtaining a first routing number from the first MSC for delivering the call to the mobile device;
if the response does not indicate that the mobile device has returned to the first MSC, waiting for a duration of time to determine whether the mobile device has registered with a second MSC of the CS domain; and
if the mobile device has registered with the second MSC within the duration of time, obtaining a second routing number from the second MSC for delivering the call to be mobile device.

2. The method of claim 1, wherein the first MSC is a last registered MSC of the mobile device known to the HLR.

3. The method of claim 1, wherein the second MSC is an MSC that the mobile device is registering.

4. The method of claim 1, further comprising:
delivering the call to the mobile device via the first MSC when the mobile device has returned to the first MSC; and
delivering the call to the mobile device via the second MSC when the mobile device has registered with the second MSC.

5. The method of claim 1, further comprising sending the USSD message to the mobile device via the first MSC.

6. The method of claim 1, wherein the duration of time is configurable by the HLR to allow registration of the mobile device with the second MSC.

7. The method of claim 6, wherein the duration of time is one second.

8. The method of claim 1, further comprising determining that the mobile device is in a packet-switched (PS) network domain prior to sending the USSD message, wherein the PS domain comprises at least one of a long term evolution (LTE) network, an internet protocol (IP) network, and a wireless local area network (WLAN).

9. The method of claim 1, wherein the CS domain comprises at least one of a third generation (3G) network, a global system for mobile communications (GSM) network, a universal mobile telecommunications system (UMTS) network, a wideband code division multiple access (W-CDMA) network, and a time division synchronous code division multiple access (TD-SCDMA) network.

10. The method of claim 1, further comprising:
if the mobile device has not registered with the second CS within the duration of time, delivering the mobile terminating call to a voicemail of the mobile device, returning the mobile terminating call as undeliverable, or identifying the mobile terminating call as complete with an absent subscriber states.

11. A circuit-switched (CS) network node for implementing a CS call delivery, comprising:
a call receiving module to receive a mobile terminating call;
a message generating module to generate an unstructured supplementary service data (USSD) message, the USSD to notify a mobile device of the call, wherein the USSD message includes a CS fallback command to return to a CS domain;
a call routing module to:
send the USSD message to a first mobile switching center (MSC);
obtain a first routing number from the first MSC for delivering the call, when a response to the USSD message indicates that the mobile device has returned to the first MSC;
wait for a duration of time to determine whether the mobile device has registered with a second MSC, when the response indicates that the mobile device has not returned to the first MSC; and
obtain a second routing number from the second MSC for delivering the call, when mobile device has registered with the second MSC within the duration of time.

12. The CS network node of claim 11, wherein the call routing module comprises a registration-wait timer to track the duration of time.

13. The CS network node of claim 12, wherein the registration wait-timer begins tracking when the response indicates that the mobile device has not returned to the first MSC.

14. The CS network node of claim 13, wherein the call is undeliverable if registration with the second MSC is not complete within the duration of time.

15. The CS network node of claim 11, wherein the CS network node is a home location register (HLR) of at least one of a third generation (3G) network, a global system for mobile communications (GSM) network, a universal mobile telecommunications system (UMTS) network, a wideband code division multiple access (W-CDMA) network, and a time division synchronous code division multiple access (TD-SCDMA) network.

16. The CS network node of claim 11, wherein the mobile terminating call is received from a gateway MSC.

17. The CS network node of claim 11, wherein the CS fallback command includes an instruction to the mobile device to exit a packet-switched (PS) domain and return to the CS domain to receive the call, and wherein the PS domain includes a mobility management entity (MME) for interfacing with the CS domain.

18. The CS network node of claim 11, wherein the mobile device includes at least one of a smartphone, a mobile phone, a personal digital assistant (PDA), a portable personal computer, a desktop computer, a multimedia player, an entertainment unit, a data communication device, and a portable reading device.

19. A non-transitory computer readable medium comprising instruction that, when executed by a processor, cause the processor to:
receive a mobile terminating call to a mobile device;
generate an unstructured supplementary service data (USSD) message, the USSD to notify a mobile device of the call and so instruct the mobile device to return to a CS domain;
send the USSD message to a first mobile switching center (MSC) of the CS domain;
obtain a first routing number from the first MSC when a response to the USSD message indicates that the mobile device has returned to the first MSC, the first routing number usable for delivering the call to the mobile device;
wait for a duration of time to determine whether the mobile device has registered with a second MSC when the response indicates that the mobile device has not returned to the first MSC; and
obtain a second routing number from the second CS MSC when the mobile device has registered with the second MSC within the duration of time, the second routing number usable for delivering the call to the mobile device.
